(19) United States
(12) Patent Application Publication
(10) Pub. No.: US 2011/0022476 A1
(43) Pub. Date: Jan. 27, 2011

(54) MEDIA PROVIDING SERVICE

(75) Inventors: Tristan Barkley, Suffolk (GB); Martin Orrell, Bedfordshire (GB)

Correspondence Address: DOCKET CLERK, P.O. DRAWER 800889, DALLAS, TX, 75380, US

(73) Assignee: THE TECHNOLOGY PARTNERSHIP PLC, Herfordshire (GB)

(21) Appl. No.: 12/734,888

(22) PCT Filed: Nov. 28, 2008
(86) PCT No.: PCT/EP2008/066479

§ 371 Date: Oct. 11, 2010

(30) Foreign Application Priority Data
Nov. 30, 2007 (GB) 0723553.4

(51) Int. Cl. G06F 3/01; G06Q 30/00; G06F 15/16; H04L 9/32

(52) U.S. Cl. 705/14.66; 715/745; 713/168

(57) ABSTRACT

A server, said server configured to receive information from a user equipment regarding interaction of the user with media content by a user of said user equipment; using said information to define preferences for said users; using said defined preferences to determine media content to be provided to said user, and transmitting information on said determined media content to said user equipment.

The present invention relates to a method and a system, and in particular but not exclusively to a method and a system for enabling media content to be provided to a user equipment.

### BACKGROUND TO THE INVENTION

There are many forms of media content which are available to a user. This media content, or simply content, may comprise audio, video, computer generated, interactive and/or textural information. The content may also include any combination of two or more of these different types of content. Currently there are many methods by which such media content may be provided to a user equipment. A user who receives content may consume the content by watching and/or listening to the content.

A first method of consuming content is via a traditional television set. Such a television set will receive a number of broadcast channels. Such a channel will be provided by a company who collects content together and provides it as a linear stream. A channel may be provided to multiple users. A user will set up their television to receive this stream and thus will be able to consume the content. The user will not be able to change the time at which specific content is received. However, since it is normally known prior to transmission what will be provided, program guides exist which enable a user to plan ahead.

There are a number of products which enable a user to time-shift the received channels. These include video recorders which record on tape and more recently DVD (digital versatile disk) and/or hard drive recorders. These enable a user to store a received channel and consume it at a later time. Thus the user schedule is not bound by the broadcaster's schedule.

Recently, television channels have been made available by a number of other methods such as cable and satellite. These methods have enabled the bandwidth of these signals to be increased. This has firstly increased the number of channels available to a user. Secondly this has increased the amount of data available for a given channel. This is used, for example, to provide multiple video streams in a given channel, for example different camera angles may be provided of the same scene. Thus the user has a degree of selectivity in how a received channel is, for example, viewed.

Other examples of the use of this increased bandwidth is in shopping channels and music television channels. In both cases however the music and/or purchasable items shown in the channel are chosen by the provider of the channel and not by the user.

Internet protocol television (IPTV) is a relatively new form of media delivery which has started to become available. In this system, a server provides a media stream to one or more connected user equipment. Such user equipment may be a traditional television set or may be a personal computer. The system may use a proprietary connection or use the internet to provide this content.

IPTV content is usually provided either as a live source (i.e. a source which is live such that the user has no control over the time at which specific content is provided) or as a playlist source. With a playlist source an IPTV content provider will define a specific playlist of content. A user, on connecting, will start receiving content from the selected item on the playlist.

Another source of media content is the Internet. Websites are now available which allow media to be posted on that website. This media may be user generated or provided from other (e.g. commercial) sources. In some cases these websites offer media content for which a licence needs to be purchased. Such content may, for example, be protected by digital rights management.

Search engines exist on the internet which enable a user to search for specific content. These search engines are often configured to search the websites. These search engines generally require a user to have a form of textual input such as a keyboard.

In many of the above examples a content provider has the role of an editor for a particular channel. In other words the content provider will select what media is to be provided to the user. A user has a degree of control, for example by using a hard drive recorder to time shift the received channel. However, the ultimate choice of content is with the provider. In this regard, a content provider creating a broadcast channel may choose a certain type of content for the channel which the user may associate with that channel. This provides a degree of predictability with regards to the content of the channel.

The extent of current system mean that there is a very large amount of content available to a user, thus making it difficult for a user to find desired content. Moreover, a user may desire specific items of different channels which are broadcast at a variety of times. Present systems make it difficult for a user to selectively choose between different channels. In addition the present forms of content provision are spread out over a variety of forms. Not all of these are available to each and every user equipment. For example, a mobile phone will be unable to receive a broadcast television channel.

These lead to an unsatisfactory user experience when trying to consume content. It is an aim of embodiments of the present invention to mitigate or overcome the above mentioned problems.

### STATEMENT OF INVENTION

According to a first aspect of the present invention there is provided a server, said server configured to: receive information from a user equipment regarding interaction with media content by a user of said user equipment; use said information to define preferences for said user; use said defined preferences to determine media content to be provided to said user, and transmit information on said determined media content to said user equipment.

Preferably said information comprises at least one of: the time of consumption of media content; the device used for consumption; the location at which consumption was made; the degree of consumption; whether specific media content was not consumed based on a user input; whether specific media content was repeatedly consumed based on a user input; a user rating; user comments.

Preferably the server is further configured to construct a model of user behaviour based on said information. More preferably the server is further configured to change said model upon said receiving information from a user equipment regarding interaction with media content by a user of said user equipment.

In some embodiments the server is configured to transmit said determined media content to said user equipment. In other embodiments the server is further configured to transmit an address of said determined media content to said user equipment.

Preferably the server is further configured to obtain information associated with said media content from a further server, said information for enabling said content to be consumed. More preferably said information comprises one or more of: an encryption key; a licence; and digital rights management information.

Preferably the server is further configured to receive advertising media from a further server in said system, said server being configured to provide said advertising media to said user equipment. More preferably consumption of said advertising media is associated with said user being able to access specific content. More preferably the server is further configured to provide said advertising media to said user equipment based on said preferences.

Preferably the server is further configured to monitor further sources of media content, and to provide media from said further sources to said user equipment on a priority basis.

According to a second aspect of the present invention there is provided a system comprising the server described above and a user equipment.

Preferably said user equipment is configured to process information on user consumption prior to transmitting said information to said server.

Preferably said user equipment is configured to store said content so that said content may be provided without a connection to a source of said content.

Preferably said user equipment is further configured to monitor content consumption when not connected to the server; and to send information on said content consumption to the server when a connection to the server is established.

Preferably wherein said user equipment is configured to transmit information associated with said stored information to a further user equipment.

According to a third aspect of the present invention there is provided a method comprising: receiving information from a user equipment regarding interaction with media content by a user of said user equipment; using said information to define preferences for said user; using said defined preferences to determine media content to be provided to said user, and transmitting information on said determined media content to said user equipment.

Preferably said information comprises at least one of: the time of consumption of media content; the device used for consumption; the location at which consumption was made; the degree of consumption; whether specific media content was not consumed based on a user input; whether specific media content was repeatedly consumed based on a user input; a user rating; user comments.

Preferably the method further comprises constructing a model of user behaviour based on said information. More Preferably the method further comprises changing said model upon said receiving information from a user equipment regarding interaction with media content by a user of said user equipment.

Preferably the method further comprises transmitting said determined media content to said user equipment.

Preferably the method further comprises transmitting an address of said determined media content to said user equipment.

Preferably the method further comprises obtaining information associated with said media content from a server, said information for enabling said content to be consumed. More preferably said information comprises one or more of: an encryption key; a licence; and digital rights management information.

Preferably the method further comprises: receiving advertising media from a server; and providing said advertising media to said user equipment. More preferably consumption of said advertising media is associated with said user being able to access specific content. More preferably said advertising media is provided to said user equipment based on said preferences.

Preferably the method further comprises monitoring further sources of media content, and providing media from said further sources to said user equipment on a priority basis.

Preferably the method further comprises processing information on user consumption prior to transmitting said information to said server.

Preferably the method further comprises storing said content so that said content may be provided without a connection a source of said content.

Preferably the method further comprises monitoring content consumption when not connected to the server; and sending information on said content consumption to the server when a connection to the server is established.

Preferably the method further comprises transmitting information associated with said stored information to a user equipment.

According to a fourth aspect of the present invention there is provided a computer-readable medium encoded with instructions that, when executed by a computer, perform: receiving information from a user equipment regarding interaction with media content by a user of said user equipment; using said information to define preferences for said user; using said defined preferences to determine media content to be provided to said user, and transmitting information on said determined media content to said user equipment.

### BRIEF DESCRIPTION OF THE DRAWINGS

For a better understanding of the present invention reference will now be made by way of example only to the accompanying drawings in which:

FIG. 1 shows a communication system in which embodiments of the present invention are realised; and

FIG. 2 shows a server according to embodiment of the present invention;

FIG. 3 shows a method embodying the invention.

### DETAILED DESCRIPTION OF PREFERRED EMBODIMENTS OF THE INVENTION

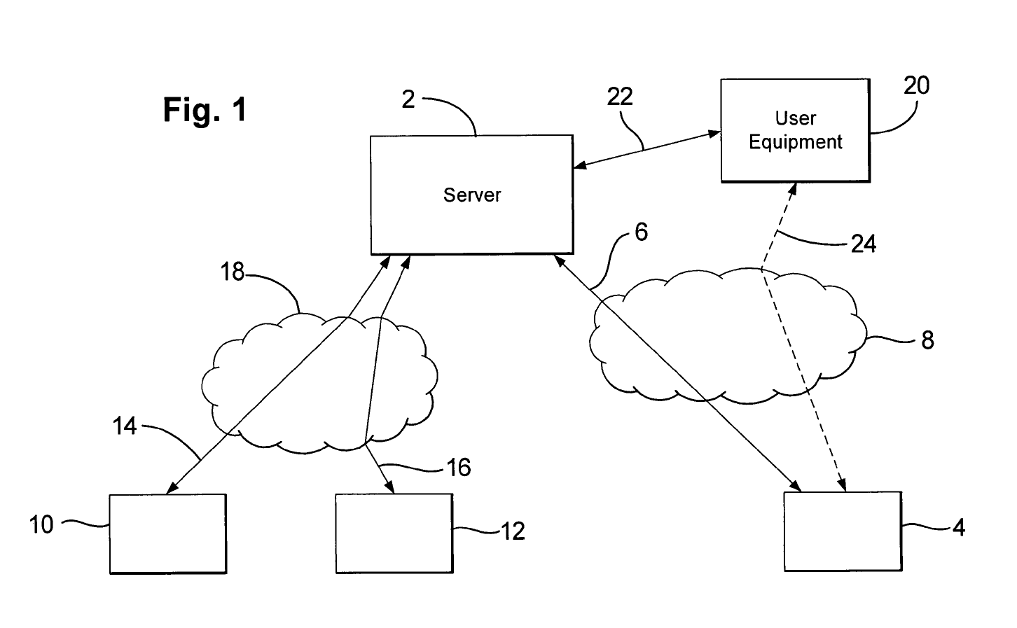

An embodiment of the invention will now be described with reference to FIG. 1. A server 2 is connected via one or more connections to one or more content providers. The connections may wireless and/or wired connections. The connections may be direct and/or indirect.

A first content provider 4 transmits a first content signal 6 via a network 8 to the server 2. Similarly, second and third content providers 10 and 12 provide second and third content signals 14 and 16 via a network 18 to the server 2.

The networks and thus the connections between the content providers and the server may be via one or more different ways. Examples include: wireless one-way transmission such as from a satellite or a terrestrial TV broadcast antenna; wireless two-way communications such as WIFI, GPRS (general packet radio service), UMTS (universal mobile telecommunications system); wired one-way communication such as cable television; and wired two-way communication such as an internet link. Each of the above described means are well know to the skilled person and will not be described further.

There are many types of content provider which may provide media content to the server. A number of examples will be described below, however this list is exemplary and not limiting.

A broadcast content provider may provide one or more linear streams of data, such as channels, to one or more receivers. Examples include: terrestrial, satellite and cable television broadcasters; and Internet broadcasters. The linear streams provided by such content providers are such that the receiver is unable to control the nature of the content in a given stream. The content provided in a particular channel will be selected by the content provider. However, within channel, one or more distinct simultaneous data streams may exist. These enable a receiver to select between different data streams. An example of this in operation is a given channel offering multiple, selectable camera angles to the receiver. Such providers are often described as linear content providers.

These linear content providers may provide prior to and/or during the broadcasting of content, an indication of the content to be broadcast. An example is a television program guide. This may be used to control the operation of a receiver prior to broadcast (for example scheduling a particular broadcast content to be recorded).

An internet based content provider such as a website or internet database may exist to provide content to the server. The server may be configured to request content from these websites. Alternatively or additionally the website may be configured to push content to the server. This means that the website will periodically send content to the server without the server explicitly requesting that particular data, although the server may have previously subscribed to the website or database. Such providers are often described as on-demand content providers.

A third form of provider may exist, known as a non-linear content provider. Such providers will be similar to the linear providers in that a channel is created by the provider with content selected by the provider. However the receiver, in this case the server, has a degree of control over when the channel is received. Such control may enable the receiver to pause, rewind and skip portions of the received channel. However the receiver will be limited to the content provided in the particular stream.

Content providers may additionally be distinguished by the nature of the content provided. A non limiting set of examples may include:

A broadcaster provides a receiver with content such as television films or documentaries. Such a broadcaster may require a license fee to be paid for the consumption of such content. Alternatively or additionally, this broadcaster may provide the content free of charge. In either case the content may also include advertisements.

A consumer content provider provides content made and uploaded by users. An example of this is the website YouTube. Such content may be provided free of charge, alternatively or additionally a fee or similar recompense may be required.

A news provider may provide live news or current affairs. Important or “breaking” news may be identified and treated differently by a receiver. For example a receiver may give priority to breaking news media content over other content. Such facilities will be described in more detail below.

An advertising content provider may provide advertising content to the server. The advertising content may be associated with revenue generation. For example a receiver may obtain credit which may be used to purchase other content. Other options for revenue generation may be possible.

In operation the server may receive the content itself. Alternatively or additionally the server may receive an indication of the nature of the content, such as an internet address.

The server may then choose to access the content at the provided address immediately or at a subsequent time. The server may store any received content.

Referring back to FIG. 1, one or more user equipment 20 may connect to the server via communication link 22. In some embodiments of the present invention the server may be provided at a location remote from the user equipment. In such cases, the connection may be provided via a network such as the internet. Alternatively, or additionally, the server may be provided as a device in close proximity to the user (for example as a set top box or as a program on a computer). In such cases the connection will be provided by a direct connection or a local area network such as a WiFi or Ethernet network. A number of short range techniques for connecting the user equipment or the server are possible, such as Bluetooth, infra-red etc.

The user equipment may comprise any suitable device. Examples include a mobile telephone or PDA (personal data assistant), a laptop or personal computer, a television set with or without a set top box or an audio system.

The server provides content to the user equipment via communication link 22. This provision of content may include one or many of the following. The server may provide a streamed audio and/or video data to the user equipment. This streamed data may be considered analogous to a channel as described above. Alternatively the server may provide a plurality of such streams to the user equipment.

Alternatively, or additionally, the user equipment may be provided with a series of links to a provider of content. The user equipment may access this content independently via a communication link with the provider, for example communication link 24.

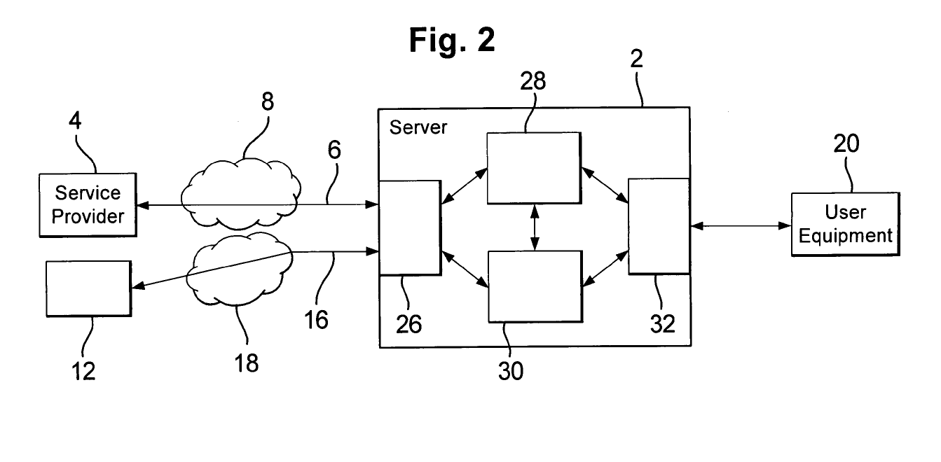

An embodiment of the server will be described in more detail with reference to FIG. 2. The server 2 may contain one or more receivers 26 for receiving content from the content providers. The nature of the receiver will depend on the type of content to be received, and may include an internet link or internet protocol network link; a broadcast receiver, such as a terrestrial broadcast receiver; or a proprietary network link, such as a cable link. The receiver may additionally be capable of transmitting requests to the content provider for specific content, that is be a transceiver. In some embodiments, requests may be transmitted on a separate system or protocol from which associated content is received. A separate transmitter may be provided.

The server may also include a processor 28 and storage unit 30 such as a memory. The processor 28 may perform operations which are stored as computer code in the storage unit 30. The storage unit 30 may store content received at the receiver/transceiver. Alternatively or additionally, the storage unit may store links, as described above, to content stored on one or more of the content providers. The storage unit 30 will also store a user profile which will be described in more detail later. The storage unit 30 may be one or a plurality of storage units 30 as are know in the art, examples of which include a hard disk, CD or DVD writable media, and volatile or non-volatile memory (such as RAM and flash-memory).

Finally, the server will be provided with communication link 32 for communicating with the user equipment 20. This may be via a variety of communication links as described in more detail above.

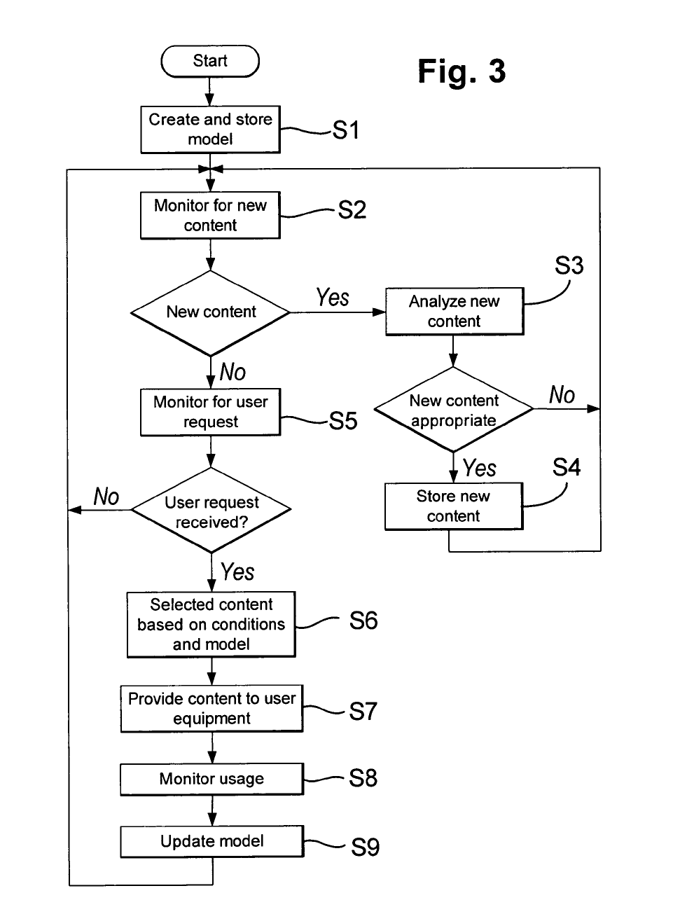

The operation of the server will now be described in more detail with reference to FIG. 3. In step S1 the server 2 will create a model or user profile for the user of user equipment 20 and store it in storage unit 30. Initially this model will be a very basic model based on generic characteristics. The server will then monitor the consumption of content by the user of the user equipment and update, or evolve, the model based on consumption.

A particular user may be associated with only one user equipment. Alternatively or additionally a plurality of users may be associated with only one user equipment. In the latter case, the user may have a facility, for example an identity or login, with which the user may distinguish themselves from other users.

In some embodiments, a particular user may be associated with a plurality of user equipment. In these cases the server may create a model based on the user's consumption on all of the user equipment. As will be described in more detail later, the model may take into account characteristics of the user equipment when forming the model.

The user model may take into account factors such as the time at which specific content is consumed, the location of the user or user equipment when this consumption occurs, and the user equipment used.

Other factors leading to consumption of content by the user may be taken into account in addition or alternatively.

As an example of this in operation, the user model would recognise that there is a difference between viewing content on a television, for which high bandwidth video content may be desired, and consuming content on a mobile telephone, for which more basic content is desired.

Alternatively, or additionally, the day on which the consumption occurs may affect what content is provided. For example, content consumed on a television in the early evening during a weekday may be the news, however at the same time at the weekend, this may include sports results.

The server may also monitor the nature of the content consumed by the user. This may include categorising different media content. This may be done by a variety of methods and categories. For example, music may be categorised by genre whereas television programs may be categorised by groupings such as drama, sitcom, reality TV, talk shows etc. Other methods of categorisation can be used in alternative embodiments of the invention. Moreover, these categorisations may get increasing detailed. For example, drama could be further subdivided into categories such as period drama, sci-fi drama etc.

The content may be associated with tags or meta-data which the server may use to identify these specific characteristics of the data.

The server may also monitor the use made of the content by the user of the user equipment. For example, if a user replays specific content multiple times, the server will note this fact. Alternatively, or additionally, if the user skips the specific content the server will recognise this and use this to improve the model of the user.

When a user skips or replays content the user equipment may be configured to allow the user to specify a reason for such actions. For example, the user may specify that the reason content was skipped was that the user does not want to consume it at any time, or that the user does not want to consume it at that particular time. Such information is clearly of benefit in improving the model.

In embodiments of the invention, a model is not only designed to look at what other users have consumed and provide content based on popularity, although this may be a factor in some models. The model may also take into account what other users who have consumed similar content have subsequently consumed. However the model takes into account the activity and/or behaviour of that user.

There have been many papers and conferences on human behaviour. One overview provided in Finlay 1990 and Finley and Beale 1992 states “user behaviour is complex but is not arbitrary. Rather, it contains recurrent patterns of behaviour. By training a pattern recognition system on known trace examples of such patterns we can analyse unseen behavioural traces and identify types of user or user behaviour”.

Such techniques may be used in embodiments of the present invention to provide this user model. As discussed above, the model is built from a content consumption perspective and analyses the choice of content based on published meta-data data stored in the content and how the content is consumed (i.e. play, skip or rewind).

The server will use the user model or profile to provide content to the user via the user equipment. In step S2, the server will monitor for new content. This may consist of the server being sent new content by the content providers, alternatively or additionally the server may contact the content providers to check for new content. When new content is detected, in step S3 the server will use the user profile to determine which content is desirable to the user. This may include categorizing desired content. This categorizing content may include, for example, defining some content as being desirable at a particular time or for a particular user equipment as described above.

Once the server has determined desirable content for a user or user equipment it may perform one or many of a number of actions to enable the content to be provided to the user equipment.

The server may, in step S4, store the content if it has already been received. The server may schedule broadcast content to be recorded. As this scheduled content is broadcast, the server may receive this content and store it in the storage means. The server may transmit a request for content and store the content as it is received. The server may store an indication, such as an address, of the content.

In step S5 the server will additionally monitor for a connection from a user equipment. When a user uses a user equipment to connect to the server, the server may then select and provide the content or indications of content to the user. The act of the user connecting to the server may involve a user switching on the equipment, or using a selection method on the equipment to indicate that content is desired.

In step S6 the server may select content based on parameters as described above. For example the time at which the user requests the content or the nature of the user equipment which is being used.

In embodiments of the invention the user equipment may offer the user the ability to specify particular preferences prior to the request for content being provided. This may, for example, include an indication of the user's mood, and thus be a request for drama over comedy or vice versa.

In step S7 the server may provide the content or indications of the content to the user equipment. If the content is provided directly to the user equipment, the user equipment is able to directly consume the content. Alternatively or additionally, if indications of content are provided, the user equipment may connect to an appropriate provider of content and request the content directly from the provider. This may be via, for example, the communication link 24 shown in FIG. 1.

As the user consumes the content or not as the case may be, in step S8 the user equipment and or the server will monitor the nature of the use. This, as previously described, will be used to modify and evolve the user profile.

Information provided by the monitoring of the usage of the content will then be used to update the model in step S9.

In some embodiments the server may be able to provide user content which is outside the parameters of the user profile. This may be provided on an occasional basis to enable the user to explore new areas which may be of interest. Based upon a user's reaction to this new content the model will be updated to reflect the user preferences.

In some embodiments the user may specify particular preferences for the model. This may include, but is not limited to: specifying particular content which the user knows that they are particularly interested in; specifying the type of content the user desires, for example free or chargeable content; specifying a restriction on content, such as a lock on adult content; and specifying the degree of freedom which the model may use in selecting alternative content.

In one modification to the system the user equipment may not always be connected to the server. If this is the case, then the user equipment may be configured to store media to be consumed. Alternatively, or additionally, the user equipment may store links to content providers so that these may be consumed when the user equipment is not connected to the server. If this is the case, the user equipment will periodically need to connect to the server to receive new content, or to receive indications of new content.

In addition, the user equipment may be configured to store indications of what content was consumed by the user. For example, this may include noting what content was paused, skipped or rewound, and the nature of content provided at any given time. This information may be processed by the user equipment to enhance the model. Alternatively, or additionally, the information may be provided to the server such that the server may update the user model.

In a further modification the user equipment may store and be able to process and modify the user model. This may allow, for example, a degree of flexibility to be operated in the user equipment when retrieving content. Moreover, it will allow the user equipment to update the model when not connected to the server, the model updated in the user equipment being uploaded upon a connection between user equipment and the server.

A user of a user equipment may wish to share their model or, specific aspects of their model, with other user equipment. This may be limited to recommending a specific media type or program type. Alternatively, or additionally, the user may share a significant amount of their profile. This enables people with shared interests to quickly build up profiles based on this shared interest. In some embodiments a user equipment may push their profile to another user or group of users. Alternatively, or additionally, a user may request parts of another user's user profile. In either case, the user not requesting or pushing may need to provide authorisation.

The content provided to the user equipment may be a mix of free and chargeable content. To pay for the chargeable content the user equipment may set up an account with the server such that the server may charge for the use of specific content. In doing so the user may set up a number of preferences. For example, the ratio of free to chargeable content which is desired; the maximum or target charge per given time period, for example a month. Alternatively, or additionally, the user may set up a fixed fee arrangement in which the user is charged a specific fee every given time period (i.e. a month) for the use of the system. This fixed fee arrangement may provide unlimited access to content or a certain amount of content.

Alternatively, or additionally, the server may be configured to provide advertisements to the user to pay for particular content. These advertisements may be provided by an advertising content provider. Alternatively, or additionally, they may be provided by any of the other content providers along with content.

Advantageously, the server is able to use the user model to tailor the advertisements to the user. Consequently, the user will receive advertisements which are related to the user's personal preferences and likes. This may be contrasted favourably with current systems in which advertisements are inserted into media without consideration of individual user's preferences. Consequently, targeted, location aware, and context sensitive advertising may be provided to a user. This advertising may be further interactive.

This pull model of providing advertisements to the user can be compared favourably with current models of advertising which interrupt use by pushing advertisements to the user. Interrupt push indicates that a regular TV program, for example, is interrupted to provide an advert.

As previously stated the server may store content for later provision to the user equipment. One advantage of some embodiments of the system is that content can be provided to the server during off peak times (for example during the night), when capacity is normally underused. The server may predict what content will be provided in subsequent days and request particular content to be transmitted during these off peak times. Alternatively, or additionally, broadcasters such as terrestrial, satellite, or cable broadcasters may use the off-peak bandwidth to provide specific content aimed at servers embodying the present invention. This advantageously maximises the networks usage.

While the invention has been particularly shown and described with reference to preferred embodiments, it will be understood to those skilled in the art that various changes in the form and detail may be made without departing from the scope of invention as defined by the appended claims.

1.-34. (canceled)

35. A server, said server configured to:
receive information from a user equipment regarding interaction with media content by a user of said user equipment;
use said information to define preferences for said user;
use said defined preferences to determine media content to be provided to said user, and
transmit information on said determined media content to said user equipment wherein
the server is further configured to construct a model of user behaviour based on said information and configured to change said model upon said receiving information from a user equipment regarding interaction with media content by a user of said user equipment.

36. The server of claim 35, wherein said information comprises at least one of
the time of consumption of media content;
the device used for consumption;
the location at which consumption was made;
the degree of consumption;
whether specific media content was not consumed based on a user input;
whether specific media content was repeatedly consumed based on a user input;
a user rating;
user comments.

37. The server of claim 35 further configured to transmit said determined media content to said user equipment or further configured to transmit an address of said determined media content to said user equipment.

38. The server of claim 35 further configured to obtain information associated with said media content from a further server, said information for enabling said content to be consumed wherein preferably said information comprises one or more of:
an encryption key;
a licence; and
digital rights management information.

39. The server of claim 35 further configured to receive advertising media from a further server in said system, said server being configured to provide said advertising media to said user equipment based on said preferences.

40. The server of claim 39 wherein consumption of said advertising media is associated with said user being able to access specific content.

41. The server of claim 40 further configured to monitor further sources of media content, and to provide media from said further sources to said user equipment on a priority basis.

42. A system comprising the server of claim 40 and a user equipment.

43. A method comprising:
receiving information from a user equipment regarding interaction with media content by a user of said user equipment;
using said information to define preferences for said user;
using said defined preferences to determine media content to be provided to said user, and
transmitting information on said determined media content to said user equipment;
constructing a model of user behavior based on said information; and changing said model upon said receiving information from a user equipment regarding interaction with media content by a user of said user equipment.

44. The method of claim 43, wherein said information comprises at least one of:
the time of consumption of media content;
the device used for consumption;
the location at which consumption was made;
the degree of consumption;
whether specific media content was not consumed based on a user input;
whether specific media content was repeatedly consumed based on a user input;
a user rating;
user comments.

45. The method of claim 43 further comprising transmitting said determined media content to said user equipment or further comprising transmitting an address of said determined media content to said user equipment.

46. The method of claim 43 further comprising obtaining information associated with said media content from a server, said information for enabling said content to be consumed wherein preferably said information comprises one or more of:
an encryption key;
a licence; and
digital rights management information.

47. The method of claim 43 further comprising:
receiving advertising media from a server; and
providing said advertising media to said user equipment based on said preferences.

48. The method of claim 47 wherein consumption of said advertising media is associated with said user being able to access specific content.

49. The method of claim 43 further comprising monitoring further sources of media content, and providing media from said further sources to said user equipment on a priority basis or further comprising processing information on user consumption prior to transmitting said information to said server or further comprising storing said content so that said content may be provided without a connection a source of said content.

50. The method of claim 44 further comprising monitoring content consumption when not connected to the server; and sending information on said content consumption to the server when a connection to the server is established or further comprising transmitting information associated with said stored information to a user equipment.

51. A computer-readable medium encoded with instructions that, when executed by a computer, perform:
receiving information from a user equipment regarding interaction with media content by a user of said user equipment;
using said information to define preferences for said user;
using said defined preferences to determine media content to be provided to said user, and
transmitting information on said determined media content to said user equipment.
